(19) United States
(12) Patent Application Publication
(10) Pub. No.: US 2001/0037255 A1
(43) Pub. Date: Nov. 1, 2001

(54) Systems and methods for providing products and services to an industry market

(76) Inventors: Roger Tambay, Quebec (CA); Anthony Richard Lettich, Johnson City, TN (US)

Correspondence Address: Charles W. Calkins, Esq., Kilpatrick Stockton, LLP, 1001 West 4th Street, Winston-Salem, NC, 27101, US

(21) Appl. No.: 09/805,261

(22) Filed: Mar. 13, 2001

Related U.S. Application Data
(60) Provisional application No. 60/189,156, filed on Mar. 14, 2000.

(51) Int. Cl. G06F 17/60

(52) U.S. Cl. 705/26; 705/8

(57) ABSTRACT

The present invention relates to systems and methods for providing products and services to an industry marketplace. The systems and methods of the present invention integrate services that are currently provided by multiple entities into a system that may be advantageously provided by a single entity to facilitate the buying and selling of products and services. An embodiment of the present invention as a site on the world wide web provides a consumer, such as a manufacturer, with an efficient method of shopping for a product by integrating, for example, product specifications, availability, ordering, shipment and delivery. An embodiment of the systems and methods of the present invention are particularly advantageous for use in providing products and services to the chemical industry, specifically the paint and coatings and the adhesives and sealants segments of the chemical industry.

### RELATED PATENT APPLICATION

This application claims priority under 35 USC 119 to, and incorporates by reference, United States Provisional Patent Application Ser. No. 60/189,156, entitled “Vertical Systems and Methods for Providing Products and Services,” filed on Mar. 14, 2000.

### FIELD OF THE INVENTION

The present invention relates to systems and methods for providing products and services to an industry marketplace on a business-to-business basis. The systems and methods of the present invention integrate services that are currently provided by multiple entities into a system that may be advantageously provided by a single entity to facilitate the buying and selling of products and services. An embodiment of the present invention comprises a site on the world wide web provides a consumer, such as a manufacturer, with an efficient method of shopping for a product by integrating, for example, product specifications, availability, ordering, shipment and delivery. An embodiment of the systems and methods of the present invention are particularly advantageous for use in providing products and services to the chemical industry, examples include the paint and coatings and the adhesives and sealants segments of the chemical industry.

### BACKGROUND

Manufacturers are generally dependent on part and product suppliers for components and ingredients necessary for production of finished goods. For example, manufacturers of paints and/or coatings are generally dependent on suppliers in the chemical industry for the ingredients necessary for producing the paints and/or coatings. The product supply chain in the industry includes feedstock producers who supply basic chemicals to raw material producers, who in turn supply commodity and specialty chemicals such as monomers, resins, pigments, solvents, cross-linkers, additives, extenders, fillers and catalysts to paint and/or coating manufacturers. The paint and/or coatings manufacturers then sell finished products through direct sales, distributors and application specific channels to end-users and original equipment manufacturers. Supporting this supply chain are a wide variety of consulting, testing, logistics and other service firms, as well as equipment and indirect supply manufacturers.

Global sales of paints and coatings in 2000 are approximately $65 billion annually. Of this amount, approximately $30 billion of raw materials are used by paint and/or coatings manufacturers on an annual basis, in addition to many other complementary products and services to support their business needs.

Paint and/or coating products generally comprise solvent(s), pigment(s), filler(s), resin(s) and additive(s). Each of these ingredients is currently a product category for the industry. Today the industry is highly fragmented and disconnected. There are several hundred raw materials and complementary products/services suppliers, and 7,000 to 10,000 paint producers globally. Although consolidation continues to occur within raw material suppliers and within the paint and/or coatings manufacturers, much inefficiency continues to exist on both the seller and buyer sides of the transactions as a result of the degree of fragmentation and difficulty in sourcing high performance raw materials. The supply structure and complexity of the specialty raw materials create sales and marketing inefficiencies for suppliers, R&D challenges at coatings companies, excess costs in the ordering and order fulfillment processes, and overall supply chain inefficiency.

Disadvantages of the current system from the paint and/or coating manufacturers point of view stem primarily from the current markets inefficiency and lack of transparency. These disadvantages include, but are not limited to, formulator/sourcing difficulties arising form the difficulty of sales and marketing functions of the suppliers connecting with the research and development functions of the formulators, purchasing difficulties, shipping difficulties and difficulties in production planning resulting from these other difficulties. Also, of the approximately 800 coatings manufacturers, 10 purchase 62% of the supplies, spending roughly $11.5 billion per year. Of the remaining 790 manufacturers, 760 purchase $50 million per year or less. These smaller manufacturers suffer disproportionately from the market inefficiencies when compared to the top 10, spending substantially more to procure a similar quantity of supplies.

Currently a manufacturer (buyer) seeking to purchase a particular ingredient for their paint or coating may need to contact multiple potential suppliers, review their product specifications, availability, shipping and delivery dates to find a supply of the ingredient. This process is repeated for each ingredient used in the paint or coating. The manufacturer must then deal with multiple shipping, delivery and invoice dates.

A manufacturer expends extensive, non-mission critical efforts sourcing raw materials, equipment and services, wasting time that could be spent on more productive (revenue generating) activities. Additionally, a manufacturer is confronted with fragmented sources of industry trends, regulations, new products, etc. that create information overload and actually prohibit the ability to stay current. Further, a manufacturer may have difficulties accessing sufficient technical expertise and problem-solving tools resulting in slower time to market and a reduction in the ability to maintain competitive advantages.

The current system also presents many disadvantages to a paint and/or coating manufacturer in the purchasing process. Spending inordinate amount of time handling a large number of low volume orders increases administration costs for the manufacturer. Further, there is an inability to standardize and reduce procurement processes as each supplier may utilize a different invoicing system and/or software. A manufacturer also faces difficulty liquidating surplus materials resulting from errors in forecasting and changing needs.

The current system also has many disadvantages for a supplier (seller) of ingredients to paint and/or coating manufacturers. Currently a supplier needs to be in contact with multiple potential purchasers, review their product needs and adjust availability, shipping and delivery dates to be able to supply each purchaser with ingredient(s). The supplier must then deal with multiple shipping, delivery and invoice dates resulting from supplying product to multiple manufacturers.

Suppliers may also face economic pressures to reduce technical and sales costs in serving lower volume, higher margin customers. Serving multiple manufacturers (buyers) with multiple product may also create inefficiencies and/or delay in the time to market for new product introductions. Further, the increased competitive environment faced by suppliers generally requires that the suppliers increase their customer reach and company visibility. In addition, a supplier of multiple ingredients may lose existing and incremental market share to competitors participating in a focused customer oriented channel.

In addition to these disadvantages, suppliers (sellers) of ingredients may face additional disadvantages. It is currently difficult for suppliers to have rapid access to industry (manufacturer) data needed to analyze market trends and other market variables. This lack of rapid access impedes the ability of suppliers to make sound business decisions.

Suppliers may also face difficulties in developing new products for the market due to deficiencies in the current process for needs identification and tailoring of products for end-use enhancements. The need to send small samples to multiple customers, particular when new products are introduced, may also be taxing to the supplier's sales and service organization. Current vehicles for obtaining feedback on performance of new product introductions may also be slow and cumbersome in the current system.

Although the foregoing discussion focuses on a segment (paint and coatings) of the chemical industry, similar situations exist in other segments of the chemical industry and in other industries.

### SUMMARY OF THE INVENTION

The present invention provides systems and methods that overcome the foregoing disadvantages and facilitate collaboration and information exchange among suppliers and manufacturers with advantages to each.

An aspect of an embodiment of the present invention is a community including suppliers of materials and services and consumers of the materials and services. In an embodiment of the present invention the community comprises a market segment of an industry. The community, however, may exist on many levels and comprise an entire industry on one level and segments of that industry on other levels.

The community may be implemented as a “virtual” community, for example as a site on a computer network such as the world wide web; a corporate intranet; a government/military network or the like. Preferably, for ease of access to the widest number of participants, the virtual community is implemented as a site on the world wide web (internet). Currently available hardware platforms, including PC's, Minicomputers and mainframes, and currently available operating systems, including UNIX, MS Windows, Mac OS and Linux, may be utilized to host the site.

According to the present invention a community is built by providing content of interest to the desired members of the community. Community building may be accomplished by providing one or more the following services: industry news; editorial reviews; career information and services; industry manuals, books and publications; discussion forums; frequently asked questions and answers; a new technology showcase; regulatory information by state and country; computer software/hardware reviews; a computer software application download library; trade association information; event calendars; industry information such as housing starts, construction trends, global news; and end-use customer product demand. In an embodiment of the present invention this content is focuses on a segment of a particular industry.

The community aspect of an embodiment of the present invention may be implemented utilizing currently available software authoring tools for the world wide web and other currently available software products.

Another aspect of an embodiment of the present invention is providing content/value-added services. The content/value-added services include but are not limited to those offerings that facilitate the work processes for an industry, or industry segment. The content/value added services may be provided in the form of information available on a site on a computer network such as the world wide web; a corporate intranet; a government/military network or the like. Preferably, for ease of access to the widest number of participants, the content/value-added services are implemented on a site on the world wide web (internet).

Examples of content/value-added services include the following: product sample services; Material Safety Data Sheets; product formulations; market information; business intelligence reports; training and education; and an “Ask the expert” problem solving function.

The content/value-added services aspect of an embodiment of the present invention may be implemented utilizing currently available software authoring tools for the world wide web and other currently available software products.

A further aspect of an embodiment of the present invention is providing commerce enabling services. The commerce enabling services are geared towards facilitating the procurement of goods and services for an industry. The commerce enabling services may be provided in the form of information and functions available on a site on a computer network such as the world wide web; a corporate intranet; a government/military network or the like. Preferably, for ease of access to the widest number of participants, the commerce enabling services are implemented on a site on the world wide web (internet).

Commerce-enabling services provided by the present invention may include one or more of the following services: multi-vendor exhaustive product catalog and storefronts; an eCatalog hub for products bought on a regular basis; a liquid exchange for high volume commodities bought on a regular basis; customer-specific pricing functionality; a request for quotation (RFQ) functionality for infrequent or 1-off purchases, typically for operating supplies; a maintenance, repair and operations (MRO) offering for systematic sourcing of operating supplies; an eVendor managed inventory systems connectivity for reduction in transaction costs; a surplus auction capability; company business rule customization; intelligent agents, for example, a “My purchasing Assistant” intelligent agent; shipping/transportation information, including carriers and transport information. Capabilities such as these create efficiencies and help to ensure accurate pricing in a market.

The service offering may be developed from user needs. The service offering could include items such as single point systems to systems integration, electronic multi-vendor managed inventory and time-saving applications such as “myPurchasingAssistant”. An additional list of service offerings is provided above.

The Commerce-enabling services may additionally comprise a marketplace for transactions among suppliers and manufacturers. The marketplace connects suppliers of materials and services with manufacturers desiring to purchase materials and/or services. The marketplace includes an information database comprising information about suppliers and information about manufacturers. The supplier information in the information database may include: corporate details (name, address, contact person etc.), product/material/service information (type, specification, details etc.), shipping information, transportation information, pricing information and the like. The manufacturer information in the information database may include similar information wherein the product/material/service information comprises information about the goods produced by the manufacturer.

The Commerce-enabling services may further comprise shipping and logistics services. The shipping services may include providing shipping services for users, for example suppliers.

The Commerce-enabling services aspect of an embodiment of the present invention may be implemented utilizing currently available software authoring tools for the world wide web and other currently available software products.

In an embodiment of the present invention, the content provider of the web site will take title to goods purchased via the web site. The content provider may also charge a transaction fee, for example a percentage of the purchase price, for providing the services offered on the web site.

An embodiment of the present invention is an e-commerce site on the world wide web that comprises community-building services; content/value-added services; and Commerce-enabling services, with each set of services comprising one or more of the services discussed above. The e-commerce site may comprise a “vertical” business model that provides vertical chain services to an industry from supplier to manufacturer and possibly further to the ultimate end users. The terminology “vertical” business model is utilized to describe a model wherein the e-commerce site of the present invention provides services throughout the supply chain.

As will be appreciated from the foregoing description, the present invention will provide many advantages to an industry or an industry segment. Well informed participants performing transactions in real-time will help to ensure the efficiency of the market. Also, the Commerce-enabling services of the invention will allow suppliers to more effectively market to the professionals in an industry who make purchase decisions. Furthermore, the efficiencies gained through the implementation of these commerce services will reduce ordering and fulfillment costs by automating and aggregating the ordering and related interactions between the various participants in the community.

Further details and advantages of the present invention are set forth below.

### BRIEF DESCRIPTION OF THE DRAWINGS

These and other features, aspects, and advantages of the present invention are better understood when the following Detailed Description of the Invention is read with reference to the accompanying drawings, wherein

FIG. 1 shows an embodiment of a computer system in accordance with the present invention, including an internet user and an application service provider.

FIG. 2 shows an embodiment of steps carried out in a formulation calculation process in accordance with the present invention.

FIG. 3 shows an embodiment of steps carried out in an “Ask the Expert” process in accordance with the present invention.

FIG. 4 shows an embodiment of a virtual catalog hub as well as steps carried out in a process in accordance with the present invention.

FIG. 5 shows an embodiment of a computer system in accordance with the present invention, including an application service provider and an ERP system of a market participant.

FIG. 6 shows an embodiment of steps carried out in a surplus auction process in accordance with the present invention.

FIG. 7 shows an embodiment of steps carried out in a purchase agent service process in accordance with the present invention.

### DETAILED DESCRIPTION OF THE INVENTION

The present invention provides systems and methods to facilitate commerce in an industry marketplace.

An embodiment of a system of the present invention including a community of participants in a market segment of an industry comprises:

a computer network;

a user;

the market segment within the industry of interest to the user;

a database for information relevant to the industry or to the market segment accessible to the user via the computer network, the database comprising at least one of: data, a value-added service and a commerce service; and

a user interface, wherein the user interface provides access to the information.

The computer network may comprise a wide area network, the Internet, or the like.

The scope, make-up and size of the community may vary depending on the makeup, size and scope of the relevant market within an industry. As markets changes, so may the community. In an embodiment of the present invention, the community comprises a single market segment within a single industry. An example is the paint and coatings market segment within the chemicals industry. Another example is the adhesives and sealants market segment within the chemical industry. In an alternate embodiment of the present invention, the community comprises a plurality of market segments, within an industry, or related industries.

A user of the system of the present invention will comprise a participant in the relevant market or market segment of the industry. For example, in an embodiment of the present invention wherein the industry is the chemical industry, the community of market participants may comprise one or more of the following users:

a feedstock producer;

a raw material producer;

a manufacturer;

an end user of the manufacturer's product;

an original equipment manufacturer; and

a supporting participant, wherein the supporting participant comprises one of: a consulting firm, a testing firm, a logistics firm and an indirect supply manufacturer.

A system of the present invention, and its component parts may be implemented utilizing standard computer hardware platforms and standard computer software. For example, the database may comprise a Microsoft SQLServer database. The database may comprise a document repository, managed, for example, by Microsoft Index Server.

The types of data in an embodiment of a system of the present invention will comprise data of relevance to the industry being served. For example, the data may comprise at least one of:

a corporate detail;

a market information report;

a business intelligence report;

an end-use customer product demand report;

a product offering;

a service offering; and

a logistics detail.

Similarly, the nature and types of value-added services will depend on the market being served by the system. For example, a value-added service may comprise at least one of:

a Material Safety Data Sheet;

a starting-point formula;

a formulation determination calculator;

a problem-solving service;

a market report;

a business intelligence report; and

a training service.

In embodiments of the present invention, the value-added service may comprise a scripted function executed within an ASP program. Alternatively, or in addition, the value-added service comprises an executant, wherein access to the executant is managed through an object brokering service.

The commerce service provided by a system of the present invention will also vary depending on the market segment. Examples of a commerce service include:

a multi-vendor product catalog;

a liquid exchange for high-volume commodities;

a customer-specific pricing functionality;

a quotation functionality;

a purchasing-agent service;

a surplus-auction service; and

a single point system-to-system integration service.

In embodiments of the present invention, the commerce service may comprise a scripted function executed within an ASP program. Alternatively, or in addition, the commerce service comprises an executant, wherein access to the executant is managed through an object brokering service.

A system of the present invention may be advantageously implemented using the Internet/World Wide Web as a computer network. In an embodiment of the present invention the user interface comprises an HTML page, for example generated by a Microsoft Active Server Pages (ASP) program.

In another aspect, the present invention provides a process for facilitating development of a community of participants in a vertically-related market comprising the steps of:

identifying a participant;

identifying an industry of interest to the participant;

identifying a market segment within the industry of interest to the participant;

compiling information relevant to the industry or to the market segment comprising at least one of: data, a value-added service and a commerce service; and

displaying the information.

The community, markets, services, users, data and implementation details may be similar to those described above with reference to a system of the present invention.

In a further aspect, the present invention provides a computer system for facilitating development on a computer network of a community of participants in a vertically-related market comprising:

a means for identifying a network user;

a means for identifying an industry of interest to the user;

a means for identifying a market segment within the industry of interest to the user;

a means for searching a database for information relevant to the industry or to the market segment comprising at least one of: data, a value-added service and a commerce service; and

a means for displaying a user interface, wherein the user interface provides access to the information.

Details relating to the markets, industry segments, services, data and users are similar to those set forth above.

Further details of the present invention are set forth in the following paragraphs with reference to an embodiment of the present invention for the paints and coatings industry, a segment of the worldwide chemical industry.

I. Overview

An embodiment of the present invention will provide many advantages to suppliers and manufacturers in the paints and coatings industry.

Participants in the paint and coatings segment of the chemicals industry are actively seeking out partners, alliances and vendors to increase the transparency and thereby the efficiency of their market. Price increases have been difficult to obtain from the end-users of paints and coatings and therefore, the suppliers and manufactures must reduce their procurement, manufacturing and selling costs to elevate or sustain profit margins. Value in the paint and/or coatings segment has been migrating toward the powerful end-users and super retailers. Paint and/or coating segment has a strong need for segment-focused, e-procurement solution that (1) enables a more efficient buying process, reducing sales, marketing, customer service and administration costs, and (2) provides access to a full range of products and services, simplifying the formulation of new paints and coatings.

An embodiment of the present invention may be implemented through a web site, for example, “PaintandCoatings.com”. From within the five product categories that make up the essential raw materials for paint and/or coatings manufacturers, additives are both highly strategic products and highly fragmented. Therefore, paintandcoatings.com could focus on providing a very broad additives product line to this industry and provide transactional efficiencies for this category, then scale to other products and services as needed by the community.

In order to provide solutions to the problems discussed in detail above, PaintandCoatings.com will provide a digital marketing channel for formulation products and services. PaintandCoatings.com's product/service offerings will fall into three broad categories: community, content/value-added and commerce as described above.

PaintandCoatings.com may have an initial focus on the $2 billion worldwide coatings additives product category, as the fragmentation and higher margins of this segment allow for greater value add through the aggregation of a rich product and content offering. Focus in this key, high-value area, critical to all paint and/or coatings formulation, will provide the key differentiator for accelerating significant traction for the PaintandCoatings.com community. Once this transaction-based community has been developed, it is expected that PaintandCoatings.com will expand its informational, product and service offerings to meet additional needs of the paint and/or coatings industry as well as the adhesives and/or sealants industry.

Paintandcoatings.com will rely on three distinct categories as its major sources of revenue: transaction revenues; revenues from services; and information based revenues.

Transaction revenues are commission fees charged to sellers and based on the degree of value provided to these users. The initial fee will be based on benchmarking with other comparable business models in similar industrial e-marketplaces, and is competitively advantaged over the current off-line channel. It is expected that the transaction revenues be one of the earliest sources of revenues and as a result of the eCommerce functionality but one where margin sustainability may be eroded over the short period.

It is expected that within the first twelve months, there will be significant competitive threat by other general-purpose marketplaces serving chemical industry. In addition, given Paintandcoatings.com's less than completely robust product and service offering at its inception and during the early stages, the competitive threat will be more significant. Over time, as the company's service offering and information offering becomes broader and deeper, it is expected that transaction fees be increased due to the degree of total value to users.

II. Community-Building Services

Community-building services will be provided to bring valuable information that is currently difficult to obtain. This list includes but is not limited to the following: Editorial reviews and industry news; Career Center; Industry manuals, books and publications; Discussion forums; FAQs; New technology showcase; Regulatory information by state and country; Software Application Download Library; Trade Association information and Events Calendars; Market information, Business Intelligence reports; Industry information such as housing starts, construction trends, global news; and End-use customer product demand.

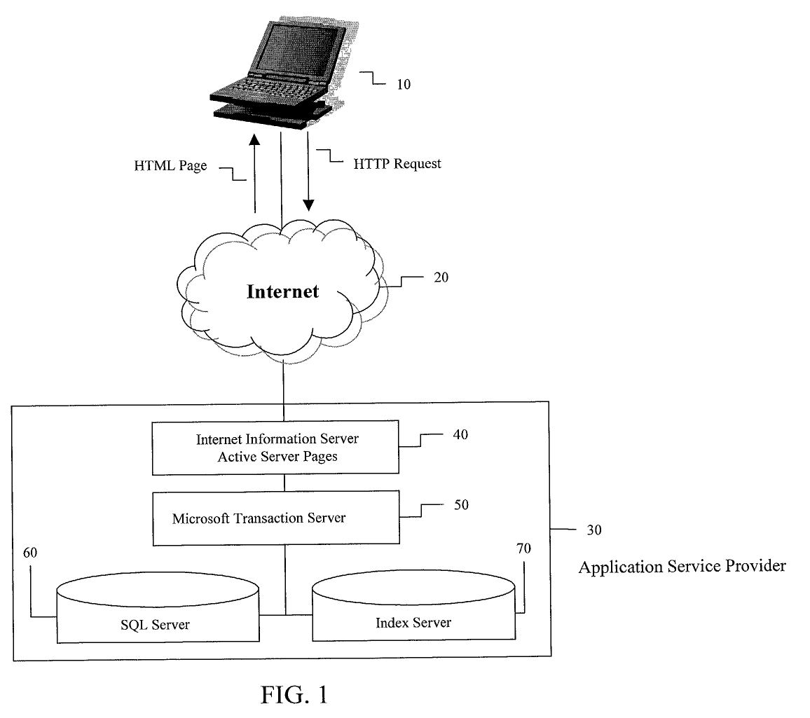

In one embodiment, an application service provider (ASP) will host PaintandCoatings.com on a web server. Referring to FIG. 1, the user 10 accesses the Internet 20 and specifies the uniform resource locator (URL) for PaintandCoatings.com (web site). The request is routed to the ASP 30, specifically to a web site, running under Microsoft Internet Information Server™ (IIS) 40, that the ASP has bound to the PaintandCoatings.com domain name. The user specifies identification information through entry an HTML form and this information is posted, using a secure method such as secured sockets layer (SSL), to the web site.

When the web site receives the identification information, a web server-based environment such as java server pages or Microsoft Active Server Pages™ (MSASP) 40 receives the posted information. The MSASP instantiates an object running under an object request broker (ORB). Under one embodiment, the object that is instantiated conforms to the Common Object Modeling (COM) standard and is managed by Microsoft Transaction Server (MTS) 50, but one skilled in the art could also utilize objects conforming to Object Management Group's (OMG) Common Object Request Broker Architecture (CORBA) or other ORB and remote procedure call (RPC) architectures.

The object receives the request and uses processing rules to formulate a response. When the object that handles user identification receives information from the MSASP, the object searches a database to confirm the identity of the user. In one embodiment of the invention, the database is managed by Microsoft SQLServer 60. In addition to confirming the identity of the user, the object retrieves additional information, including the industry(s) and market segment(s) that are of interest to the user.

The object may search the same database or additional databases as well as document repositories for information that is relevant to the identified industry(s) and market segment(s). In one embodiment of the invention, the document repository is managed by Microsoft Index Server (MSIS) 70.

The MSASP combines all the information retrieved from the various data sources into a extensible markup language (XML) document and associates the XML document with a style sheet (XSL), producing a hyper-text markup language (HTML) page for presentation to the user. The HTML page can contain excerpts from various articles and other sources of information as well as hyperlinks for access to the entire documents.

III. Content/Value-Added Services

Content/value-added services will include but are not limited to those offerings that facilitate the work processes for formulators. Examples of these include the following: Sample services; Material Safety Data Sheets; Starting-point formulas; Solvent formulation program wizard; Polyester (resin) formulation program wizard; Training and Education; and an “Ask the expert” problem-solving function.

In one embodiment of the invention, access to these services is provided on an HTML page generated with an MSASP. The service itself may be provided by either a client-side or server-side program. In one embodiment, a specific service consists of an HTML form. Referring again to FIG. 1, a user 10 enters the required information on a form and submits the form to the web site at the ASP 30. The MSASP under IIS 40 processes the request and, if necessary, instantiates an object under MTS 50. The object performs the processing logic for the service. If necessary, the object queries a database 60 for necessary information and then the object responds to the MSASP. The MSASP continues processing, creating an HTML page for the user and sending the document to the user.

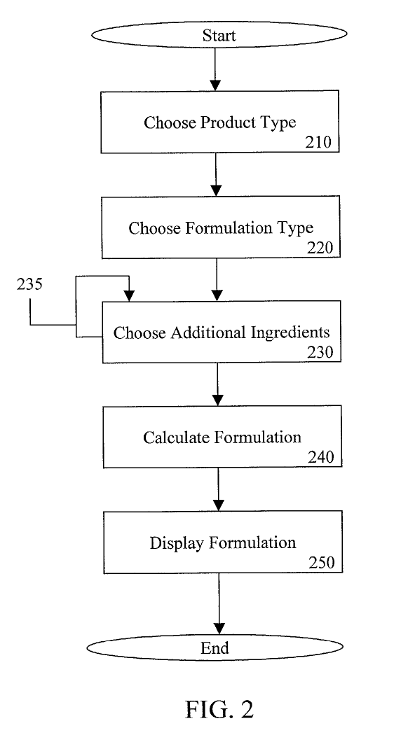

In one embodiment of the invention, a formulation calculator is available to the user. Currently, a user wishing to devise a formulation must perform research using many separate sources to determine industry guidelines and inherent properties relating to the ingredients in a formulation. The formulation calculator helps to alleviate this burden. Referring to FIG. 2, the user first selects the type of product the user wishes to formulate 210. For example the user may choose to formulate a polyester resin. The user then selects the formulation type to be created 220. Possible examples of a formulation type would be liquid, granular and emulsion. The user continues by selecting additional necessary ingredients 230. This step may be repeated as necessary 235. Once the user has selected all the necessary ingredients, the formulation calculator will display a formulation combining these ingredients according to generally accepted industry and product-specific standards 240. The result is then presented to the user 250.

An embodiment of the invention can also present training and education services to the user. A series of training topics for which material has been previously prepared may be indexed. The indexing process includes relating the training material to various industries and market segments. When the database or document repository is searched by a user, the access to the relevant training topics is included on the resultant HTML page.

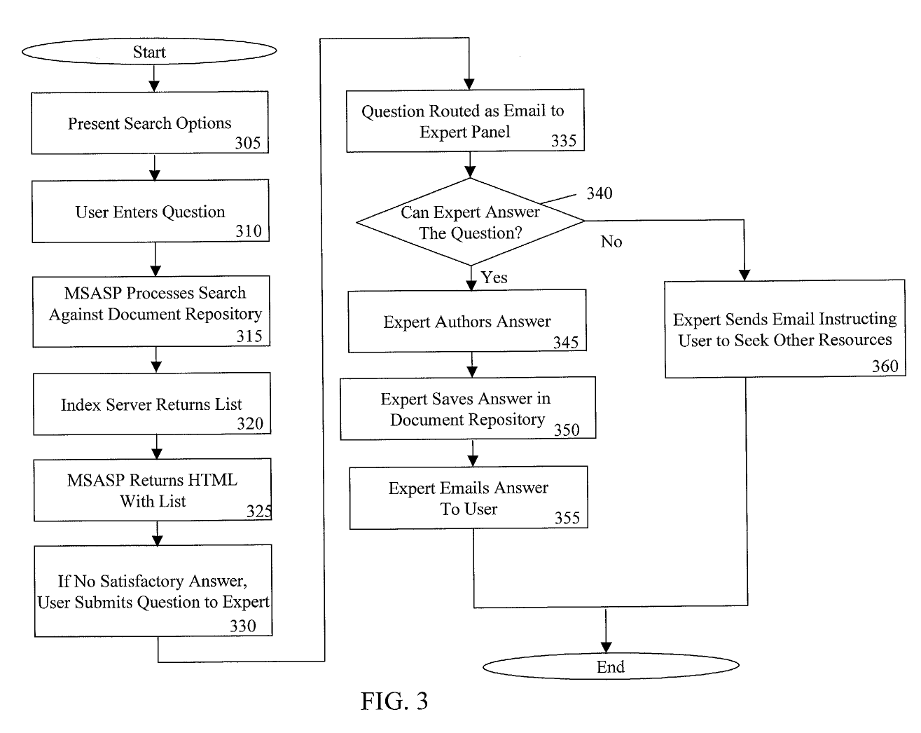

Users of the embodiment of the invention will often have questions regarding the products and services available on the web site. For example a user may want to know the availability of a service offering in a specific community or want to determine the proper application rates of specific products. To answer these questions, the invention will include an “Ask the Expert” service. In one embodiment of the invention, the “Ask the Expert” service will comprise one or more knowledge bases that may be constructed prior to their availability on the web site and that are then accessible to the user from an HTML page. FIG. 3 shows a second embodiment of the invention that will provide answers to these types of questions using an indexed document repository.

As shown in FIG. 3, the embodiment presents an HTML page containing a form, wherein the form comprises a field in which the user can specify a question 305. The user enters the question and posts the HTML form to the web server 310. The posted form is processed by an MSASP 315. The MSASP executes a search against MSIS, and MSIS returns a list of documents and document abstracts that satisfy the search criteria as specified by the user 320. The MSASP presents this list of documents and abstracts to the user as an HTML page 325. Included on this page is a link that allows the user to submit a question to an “expert” if none of the documents answer the question posed by the user 330. If the user chooses to submit a question to an expert, the question is sent as an electronic mail message to a panel of experts within the specific industry or market segment of interest to the user 335. If one of the panel members is qualified to answer the question 340, the member authors a response as a document comprising the question as the document title and the question as well as the response as the body of the document 345. The member saves this document in the document repository 350 and emails the document to the user who posed the question 355. If none of the panel members is able to answer the question, an email is sent to the user directing the user to seek other resources for an answer to the question 360.

IV. Commerce-Enabling Services

Commerce-enabling services will be geared towards facilitating the procurement of goods and services for this industry. This list includes the following: Multi-vendor exhaustive product catalog and storefronts; eCatalog hub for additives and specialty products bought on a regular basis; Liquid exchange for high volume commodities bought on a regular basis; Customer-specific pricing functionality; RFQ for infrequent or 1-off purchases, typically for operating supplies; MRO offering for systematic sourcing of operating supplies; eVendor Managed Inventory; Systems connectivity for reduction in transaction costs; Surplus auction capabilities; Company business rule customization; “My purchasing Assistant” intelligent agent; The starting point of the commerce offering will be an e-catalog for the procurement of additives and other specialties. This is due to the customer-stated need for a procurement solution for these repetitive low volume, high dollar purchases that consume a high amount of time and energy.

Additives that will be made available may include one or more of the following: Rheology Modifiers (e.g. Clays, ASE, HEUR, CAB); Dispersants (e.g. Polyamide & Acrylic); Wetting Agents (e.g. Silicones/polymeric); Coalescing aids (e.g. TXOL, glycol ethers); Adhesion Promoters (e.g. CPO); Biocides (e.g. carbamate; oxazolidines); Defoamers (e.g. silicone, some oil); Corrosion Inhibitors (e.g. Chromium); Slip Rub Agents (e.g. silicone); Anti-oxidants; Light Stabilizers; and Amino crosslinkers.

The ability to easily and efficiently purchase goods and services directly from an e-commerce online storefront is critical to the success of the online storefront. When the procurement process is complex, as in the chemical industry, commerce-enabling services that provide more than the simple ability to sell and purchase goods are also critical. An embodiment of the invention addresses this critical need by providing industry or market segment-specific e-Commerce-enabling services.

The embodiment includes a product catalog and an online storefront. The product catalog comprises products from multiple vendors. The vendors exist at all levels of the supply chain, including for example feedstock producers, manufacturers and supporting participants such as consulting firms.

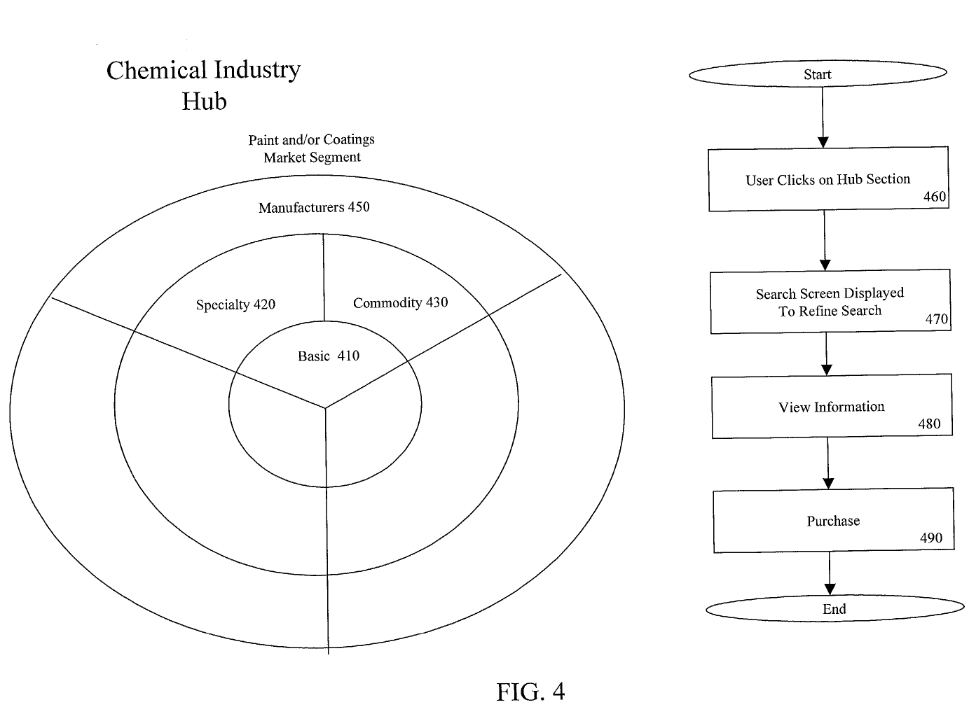

Referring to FIG. 4, an embodiment of the invention may also include an eCatalog hub for additives and specialty products bought on a regular basis. The eCatalog hub is a virtual representation of the supply chain for the industry or market segment presented as concentric circles representing various levels of the supply chain and spokes representing divisions between various market segments of an industry. The innermost rings of the hub comprise the lowest level of the supply chain such as the basic chemicals supplied by feedstock producers 410. Visually progressing towards the outside of the hub, the next ring comprises the specialty 420 and commodity 430 chemical suppliers. Finally, the outer ring comprises manufactured products 450. A user may click on any section of hub to identify the subset of products and services that are of interest to that user 460. Once the user has selected the subset, the embodiment presents the user with an HTML page that allows the user to further refine the product and service search 460. When the user submits this form, the user can perform other standard commerce functions such as purchasing a product 480 or viewing product information 490.

An embodiment of the invention also includes several services that enable the user to procure products and services in a highly efficient, automated manner. An example of such a service is a Liquid Exchange for high volume commodities. A user can specify that periodic purchases be made automatically under a pre-defined set of specifications. Another example is a customer-specific pricing functionality. The price for a specific product is determined automatically based on a number of factors, including the purchase history of the customer and the volume of the purchase.

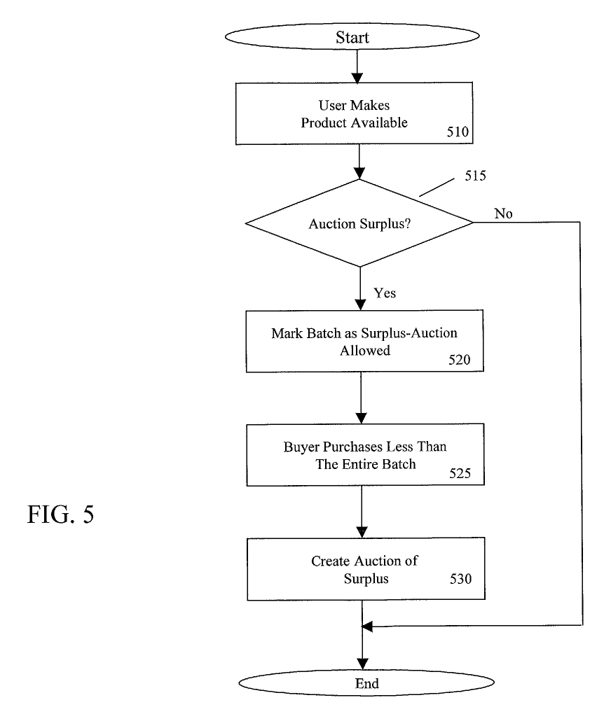

Also, an embodiment of the invention may include a surplus auction service to increase the efficiency of the commerce transactions occurring on the web site. As shown in FIG. 5, a user makes an original quantity of a product available for sale as a batch 510. The user is then presented with the option of allowing a purchase of less than the original amount and a further option to automatically auction any surplus, or the difference between the purchase quantity and the original quantity made available for sale 515. If the user chooses a surplus auction, the user may further specify attributes of the auction such as a reserve price. The product batch is marked as allowing a surplus auction 520. If a buyer then purchases less than the total batch 525, the surplus is automatically made available for sale by auction 530. The attributes of the auction are as originally specified by the seller.

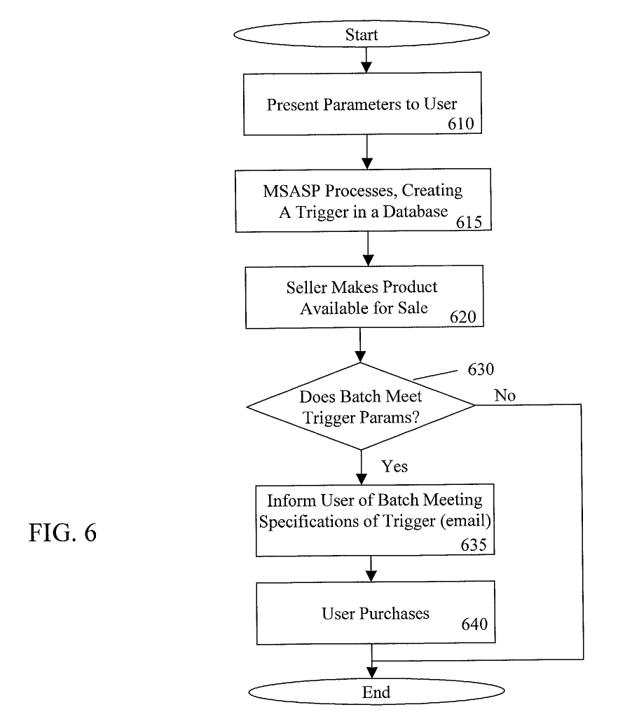

An embodiment of the invention includes an intelligent agent service, “My Purchasing Assistant,” (purchase agent service) to further increase the efficiencies of the commerce transactions on the web site. The purchase agent service allows the user to enter a set of parameters regarding a purchase to be made in the future. These parameters may include but are not limited to: the beginning and ending date within which the service is active, the desired product or service, the acceptable supplier and the price at which the purchase should be triggered. As shown in FIG. 6, the purchase agent service initially provides the user with a plurality of purchasing parameters in an HTML form 610. The user sets parameters by entering data directly or by selecting elements from a finite list such as in a drop-down combo box. The user submits the form to the web site and the MSASP that processes the form creates an entry in a database 615. Later, a seller makes a batch of product available for sale at a specific price 620.

The system evaluates any agents which are stored in the database to determine if the triggering parameters associated with the agent are satisfied 630. If so, the user who initiated the purchasing agent service is informed by email that a product batch meeting the user's set of parameter is available 635. Once the user has information regarding the product batch that is available, the user may decide to purchase the batch 640. Other embodiments of the invention might include the ability to automatically complete the purchase with no interaction from the user other than the initial entry of the purchase agent service parameters.

An embodiment of this invention includes further services to increase the efficiency of transactions within an industry or market segment. One such service is a request for quotation (RFQ) service for infrequent purchases. The prospective purchaser can submit a request detailing the specifications or the required product or service. Sellers who can provide the desired product or service can respond with a quotation, including a price. The buyer and seller can then complete the transaction on-line.

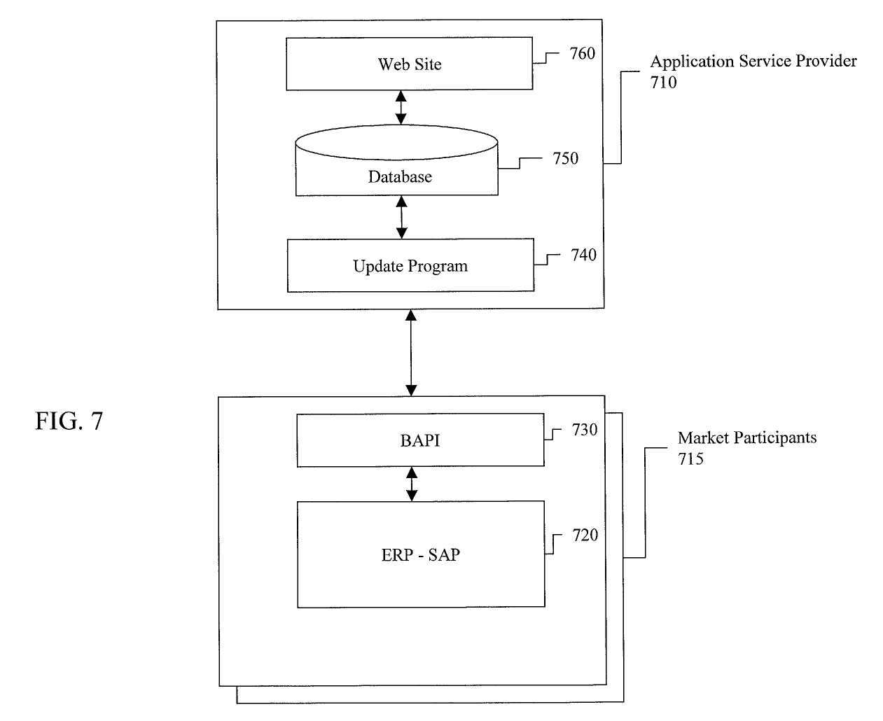

An embodiment of the invention can further increase transparency and efficiency within the industry or market segment through systems integration with the market participants. As shown in FIG. 7, an embodiment of the invention may consist of a web site 760 and a corresponding database 750 on an ASP 710. The database contains inventory information regarding market participants 715. It is critical that inventory information on the electronic storefront reflects the current state of inventory for the market participant.

Generally, a market participant will have a software application for managing inventory. Medium to large businesses generally have an enterprise resource planning (ERP) system such as SAP or BAAN 720. In addition to inventory and sales information, an ERP system may also include manufacturing, distribution, financials and personnel information. Many ERP systems contain remote procedure call (RPC) services to allow an external application to access functions within the ERP system. SAP includes a Business Application Programming Interface (BAPI) to support this functionality. In an embodiment of the invention, a computer program is periodically executed on the ASP server 740. The update program initializes an RPC to a BAPI in the market participant's SAP instance 730. The BAPI returns the inventory information of the market participant, and the update program updates the database for the shared catalog with the inventory information.

An embodiment of the invention may also comprise other instances of systems connectivity. The systems connectivity will lead to more efficient transactions by providing a conduit for business-to-business (B2B) commerce.

The foregoing description of the preferred embodiments of the invention has been presented only for the purpose of illustration and description and is not intended to be exhaustive or to limit the invention to the precise forms disclosed. Numerous modifications and adaptations thereof will be apparent to those skilled in the art without departing from the spirit and scope of the present invention.

That which is claimed:

1. A system for conducting commerce including a community of participants in a market segment of an industry comprising:
a computer network;
a user;
the market segment within the industry of interest to the user;
a database for information relevant to the industry or to the market segment accessible to the user via the computer network, the database comprising at least one of: data, a value-added service and a commerce service; and
a user interface, wherein the user interface provides access to the information.

2. The system of claim 1 wherein the computer network comprises the Internet.

3. The system of claim 1 wherein the community comprises a market segment within an industry.

4. The system of claim 1 wherein the community comprises a plurality of market segements within an industry.

5. The system of claim 1 wherein the system further comprises one or more of the following users:
a feedstock producer;
a raw material producer;
a manufacturer;
an end user of the manufacturer's product;
an original equipment manufacturer; and
a supporting participant, wherein the supporting participant comprises one of: a consulting firm, a testing firm, a logistics firm and an indirect supply manufacturer.

6. The system of claim 1 wherein the data comprise at least one of:
a corporate detail;
a market information report;
a business intelligence report;
an end-use customer product demand report;
a product offering;
a service offering; and
a logistics detail.

7. The system of claim 1 wherein the value-added service comprises at least one of:
a Material Safety Data Sheet;
a starting-point formula;
a formulation determination calculator;
a problem-solving service;
a market report;
a business intelligence report; and
a training service.

8. The system of claim 1 wherein commerce service comprises at least one of:
a multi-vendor product catalog;
a liquid exchange for high-volume commodities;
a customer-specific pricing functionality;
a quotation functionality;
a purchasing-agent service;
a surplus-auction service; and
a single point system-to-system integration service.

9. A process for facilitating development of a community of participants in a vertically-related market comprising the steps of:
identifying a participant;
identifying an industry of interest to the participant;
identifying a market segment within the industry of interest to the participant;
compiling information relevant to the industry or to the market segment comprising at least one of: data, a value-added service and a commerce service; and
displaying the information.

10. The process of claim 9, wherein the community comprises a single industry.

11. The process of claim 9, wherein the community comprises a single market segment within a single industry.

12. The process of claim 9, wherein the community comprises the chemicals industry.

13. The process of claim 9, wherein the community comprises the paint and coatings market segment of the chemicals industry.

14. The process of claim 9, wherein the community comprises the adhesives and sealants market segment of the chemicals industry.

15. The process of claim 9, wherein the community of market participants comprises:
a feedstock producers;
a raw material producer;
a manufacturer;
an end user of the manufacturer's product;
an original equipment manufacturer; and
a supporting participant, wherein the supporting participant comprises one of: a consulting firm, a testing firm, a logistics firm and an indirect supply manufacturer.

16. The process of claim 9, wherein the data comprises at least one of:
a corporate detail;
a market information report;
a business intelligence report;
an end-use customer product demand report;
a product offering;
a service offering; and
a logistics detail.

17. The process of claim 9, wherein the value-added service comprises at least one of:
a Material Safety Data Sheet;
a starting-point formula;
a formulation determination calculator;
a problem-solving service;
a market report;
a business intelligence report; and
a training service.

18. The process in claim 9, wherein the commerce service comprises:
a multi-vendor product catalog;
a liquid exchange for high-volume commodities;
a customer-specific pricing functionality;
a quotation functionality;
a purchasing-agent service;
a surplus-auction service; and
a single point system-to-system integration service.

19. A computer system for facilitating development on a computer network of a community of participants in a vertically-related market comprising:
a means for identifying a network user;
a means for identifying an industry of interest to the user;
a means for identifying a market segment within the industry of interest to the user;
a means for searching a database for information relevant to the industry or to the market segment comprising at least one of: data, a value-added service and a commerce service; and
a means for displaying a user interface, wherein the user interface provides access to the information.

20. The system of claim 19, wherein the communications network comprises the Internet.

21. The system of claim 19, wherein the community comprises a single industry.

22. The system of claim 19, wherein the community comprises a single market segment within a single industry.

23. The system of claim 19, wherein the community comprises the chemicals industry.

24. The system of claim 19, wherein the community comprises the paint and coatings market segment of the chemicals industry.

25. The system of claim 19, wherein the community is limited to the adhesives and sealants market segment of the chemicals industry.

26. The system of claim 19, wherein the community of market participants comprises:
a feedstock producers;
a raw material producer;
a manufacturer;
an end user of the manufacturer's product;
an original equipment manufacturer; and
a supporting participant, wherein the supporting participant comprises one of: a consulting firm, a testing firm, a logistics firm and an indirect supply manufacturer.

27. The system of claim 19, wherein the database comprises a Microsoft SQLServer database.

28. The system of claim 19, wherein the database comprises a document repository.

29. The system of claim 19, wherein the database comprises a document repository, wherein access to the document repository is managed by Microsoft Index Server.

30. The system of claim 19, wherein the data comprises at least one of:
a corporate detail;
a market information report;
a business intelligence report;
an end-use customer product demand report;
a product offering;
a service offering; and
a logistics detail.

31. The system of claim 19, wherein the value-added service comprises at least one of:
a Material Safety Data Sheet;
a starting-point formula;
a formulation determination calculator;
a problem-solving service;
a market report;
a business intelligence report; and
a training service.

32. The system of claim 19, wherein the commerce service comprises:
a multi-vendor product catalog;
a liquid exchange for high-volume commodities;
a customer-specific pricing functionality;
a quotation functionality;
a purchasing-agent service;
a surplus-auction service; and
a single point system-to-system integration service.

33. The system in claim 19, wherein the user interface comprises an HTML page.

34. The system in claim 19, wherein the user interface comprises an HTML page generated by a Microsoft Active Server Pages (ASP) program.

35. The system in claim 19, wherein the value-added service comprises a scripted function executed within an ASP program.

36. The system in claim 19 wherein the commerce service comprises a scripted function executed within an ASP program.

37. The system in claim 19, wherein the value-added service comprises an executant, wherein access to the executant is managed through an object brokering service.

38. The system in claim 19, wherein the commerce service comprises an executant, wherein access to the executant is managed through an object brokering service.
